(19) United States
(12) Patent Application Publication
(10) Pub. No.: US 2025/0379258 A1
(43) Pub. Date: Dec. 11, 2025

(54) SECONDARY BATTERY

(71) Applicant: Prime Planet Energy & Solutions, Inc., Tokyo (JP)

(72) Inventor: Hiromasa YAGI, Toyonaka-shi (JP)

(21) Appl. No.: 19/221,516

(22) Filed: May 29, 2025

(30) Foreign Application Priority Data
Jun. 7, 2024 (JP) 2024-092920

(51) Int. Cl. H01M 10/0583; H01M 10/0525; H01M 50/342; H01M 50/46; H01M 50/466

(52) U.S. Cl. CPC H01M 10/0583; H01M 10/0525; H01M 50/3425; H01M 50/46; H01M 50/466; H01M 2200/20

(57) ABSTRACT

A secondary battery according to the present disclosure includes an electrode body with a zigzag structure, and an electrolyte solution. The electrode body includes a first outer surface and a second outer surface. The electrolyte solution includes a surplus solution that is disposed at least between the first outer surface and a case. The separator includes a plurality of first protrusion parts including a first bent part on the first outer surface, and a plurality of second protrusion parts including a second bent part on the second outer surface. A plurality of penetration holes are provided at the first protrusion part. A protrusion length of the second protrusion part is larger than a protrusion length of the first protrusion part.

### CROSS REFERENCE TO RELATED APPLICATION

This application claims the benefit of priority to Japanese Patent Application No. 2024-092920 filed on Jun. 7, 2024. The entire contents of this application are hereby incorporated herein by reference.

### BACKGROUND OF THE DISCLOSURE

### 1. Field

The present disclosure relates to a secondary battery.

### 2. Background

One of the conventionally known secondary batteries includes an electrode body that has a zigzag structure where a separator with a band-like shape is folded alternately so as to have a zigzag shape and a plurality of electrodes (positive electrodes and negative electrodes) are held, and an electrolyte solution (for example, see Japanese Patent Application Publication No. 2007-305464, Japanese Patent Application Publication No. 2010-157366, Japanese Patent Application Publication No. 2013-149627, Japanese Patent Application Publication No. 2016-143550, Japanese Patent Application Publication No. 2018-067396, and WO 2019/064740).

### SUMMARY

According to the present inventor's examination, in a secondary battery including an electrode body with a zigzag structure and an electrolyte solution, the entrance and exit of the electrolyte solution to and from an electrode plate that is positioned inside a separator may be interrupted at a folded part of the separator. This causes the local shortage of the electrolyte solution that is kept and circulated in the electrode body, which results in a problem that so-called liquid shortage easily occurs or the salt concentration in the electrode body becomes inhomogeneous. Such a problem easily occurs in an aspect where charging and discharging at a high rate are repeated, for example, particularly in the application for a vehicle.

The present disclosure has been made in view of the above circumstances, and a main object is to provide a secondary battery in which an electrolyte solution is easily kept and circulated in an electrode body.

A secondary battery according to the present disclosure includes an electrode body that has a zigzag structure where a separator with a band-like shape is folded alternately so as to have a zigzag shape and a plurality of positive electrodes and a plurality of negative electrodes are held by the separator with the zigzag shape, an electrolyte solution, and a case that accommodates the electrode body and the electrolyte solution. The electrode body includes a pair of outer surfaces that are disposed so as to face each other, the pair of outer surfaces including a first outer surface where a first end surface of the positive electrode and a first end surface of the negative electrode are disposed, and a second outer surface where a second end surface of the positive electrode and a second end surface of the negative electrode are disposed. The electrolyte solution includes a surplus solution that is disposed at least between the first outer surface and the case. The separator includes a plurality of first protrusion parts that protrude relative to the first end surface of the negative electrode on the first outer surface, and a plurality of second protrusion parts that protrude relative to the second end surface of the negative electrode on the second outer surface. The first protrusion part includes a first bent part of the separator, and the second protrusion part includes a second bent part of the separator. A plurality of penetration holes are provided at the first protrusion part. A protrusion length L2 of the second protrusion part is larger than a protrusion length L1 of the first protrusion part.

In the above structure, the electrolyte solution is easily kept and circulated in the electrode body.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a perspective view schematically illustrating a secondary battery according to one embodiment;

FIG. 2 is a perspective view in which the secondary battery in FIG. 1 is inverted in an up-down direction;

FIG. 3 is a schematic longitudinal cross-sectional view taken along line III-III in FIG. 1;

FIG. 4 is a schematic longitudinal cross-sectional view taken along line IV-IV in FIG. 1;

FIG. 5 is a developed view illustrating a part of a separator according to one example; and

FIG. 6 is a diagram corresponding to FIG. 1 according to a modification.

### DETAILED DESCRIPTION OF THE PREFERRED EMBODIMENTS

Preferred embodiments of the present disclosure will hereinafter be described with reference to the drawings as appropriate. Matters that are not mentioned in the present specification and that are necessary for the implementation of the present disclosure can be grasped as design matters of those skilled in the art based on the prior art in the relevant field.

The present disclosure can be implemented on the basis of the contents disclosed in the present specification and common technical knowledge in the relevant field. Note that in the drawings below, the members and parts with the same operation are denoted by the same reference signs and the overlapping description may be omitted or simplified. Moreover, in the present specification, the notation “A to B” for a range signifies a value more than or equal to A and less than or equal to B, and is meant to encompass also the meaning of being “more than A” and “less than B”.

Note that the term “secondary battery” in this specification refers to a general electrical energy storage device capable of being charged and discharged repeatedly. Note that, in the present specification, the term “lithium ion secondary battery” refers to a secondary battery that uses lithium ions as a charge carrier and can be charged and discharged by transfer of the lithium ions between positive and negative electrodes.

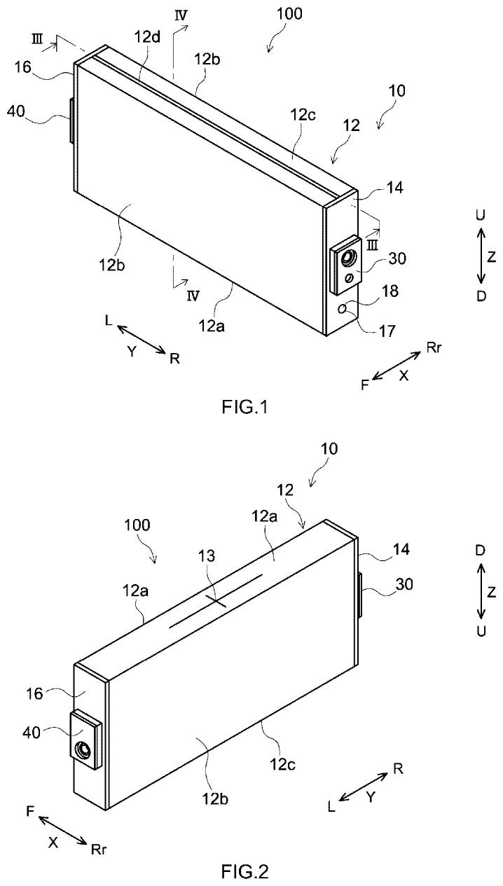

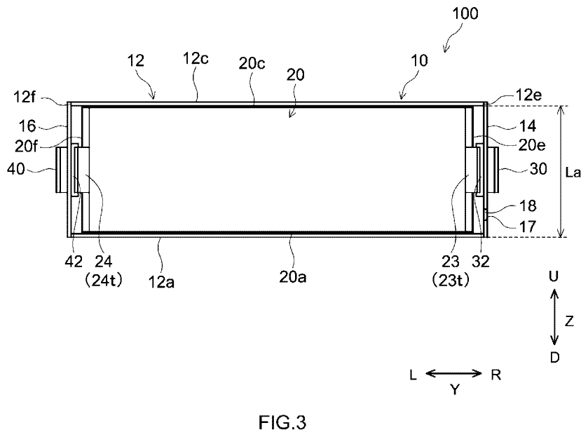

FIG. 1 is a perspective view of a secondary battery 100 according to one embodiment. FIG. 2 is a perspective view in which the secondary battery 100 in FIG. 1 is inverted in an up-down direction. FIG. 3 is a schematic longitudinal cross-sectional view taken along line III-III in FIG. 1, and illustrates an internal structure of the secondary battery 100. The secondary battery 100 can be installed as illustrated in FIG. 1 when the secondary battery 100 is actually used (for example, when installed in a vehicle in the application for the vehicle). In the following description, reference signs L, R, F, Rr, U, and D in the drawings respectively denote left, right, front, rear, up, and down, and reference signs X, Y, and Z in the drawings respectively denote a short side direction of the secondary battery 100, a long side direction that is orthogonal to the short side direction, and an up-down direction that is orthogonal to the short side direction and the long side direction. The short side direction X and the long side direction Y are typically a horizontal direction. The up-down direction Z is typically a vertical direction.

The secondary battery 100 according to this embodiment is a lithium ion secondary battery. Thus, the secondary battery 100 can have excellent battery characteristics such as high energy density and high capacity. In another embodiment, the secondary battery may be a secondary battery other than the lithium ion secondary battery (for example, sodium ion secondary battery or the like). The secondary battery 100 is preferably a nonaqueous electrolyte solution secondary battery such as a lithium ion secondary battery.

As illustrated in FIG. 3, the secondary battery 100 includes a case 10, an electrode body 20, and an electrolyte solution (not illustrated). Moreover, the secondary battery 100 further includes a positive electrode terminal 30 and a negative electrode terminal 40.

### <Case>

The case 10 is a housing that accommodates the electrode body 20 and the electrolyte solution. As illustrated in FIG. 1 and FIG. 2, the case 10 has an outer shape that is a flat bottomed cuboid shape here. That is to say, the case 10 has a square shape. Therefore, the secondary battery 100 is a square lithium ion secondary battery. However, the shape of the case 10 is not limited to this shape. The case 10 is preferably square because the space efficiency becomes high when a battery module is formed using a plurality of the secondary batteries 100.

The material of the case 10 may be similar to the conventionally used material (for example, metal, resin, or the like) without particular limitations. The material of the case 10 is preferably metal, and more preferably aluminum, an aluminum alloy, iron, an iron alloy, or the like from the viewpoints of strength, thermal conductivity, and the like. Note that the case 10 may be formed of a laminate film.

As illustrated in FIG. 1 to FIG. 3, the case 10 includes a case main body 12, a first sealing plate 14, and a second sealing plate 16. The case main body 12 has a rectangular tubular shape. As illustrated in FIG. 3, the case main body 12 includes a first opening 12e at one end part in the long side direction Y and a second opening 12f at the other end part in the long side direction Y. The first sealing plate 14 seals the first opening 12e and the second sealing plate 16 seals the second opening 12f. The case 10 is integrated in such a way that the first sealing plate 14 and the second sealing plate 16 are bonded (for example, bonded by welding) at the first opening 12e and the second opening 12f of the case main body 12, respectively. The case 10 is hermetically sealed. Therefore, the secondary battery 100 is a closed type battery.

The case 10 has a hexahedral shape, and includes a pair of first surfaces, a pair of second surfaces, and a pair of third surfaces. Specifically, as illustrated in FIG. 1, the case main body 12 includes a bottom surface 12a with an approximately rectangular shape, a pair of long side surfaces 12b extending from long sides of the bottom surface 12a and facing each other, and a top surface 12c connecting upper end parts of the pair of long side surfaces 12b. The top surface 12c has an approximately rectangular shape. The top surface 12c faces the bottom surface 12a. Here, the bottom surface 12a and the top surface 12c constitute the pair of first surfaces, and the pair of long side surfaces 12b constitute the pair of second surfaces. The area of the long side surface 12b is preferably larger than the area of the bottom surface 12a and larger than the area of the top surface 12c. The case main body 12 is formed by, for example, bending one sheet of metal plate into a tubular shape and bonding (for example, bonding by welding) a joint. In the illustrated example, a welding bonding part 12d exists on the top surface 12c. Note that the welding bonding part 12d may exist at the bottom surface 12a or at the long side surface 12b.

As illustrated in FIG. 2, the bottom surface 12a of the case main body 12 includes a gas exhaust valve 13. The gas exhaust valve 13 is configured to fracture when pressure inside the case 10 reaches a predetermined value or more and discharge a gas in the case 10 to the outside of the case 10. Although one gas exhaust valve 13 is provided in this embodiment, two or more gas exhaust valves 13 may be provided. Moreover, although the gas exhaust valve 13 is provided on the bottom surface 12a in this embodiment, the present disclosure is not limited to this example. In another embodiment, the gas exhaust valve 13 may be provided on other surface than the bottom surface 12a, for example the long side surface 12b, the top surface 12c, the first sealing plate 14, the second sealing plate 16, or the like. The area of the gas exhaust valve 13 may be determined arbitrarily.

In this embodiment, the gas exhaust valve 13 is a cross-shaped notch. However, the shape of the gas exhaust valve 13 is not limited in particular. In another embodiment, the gas exhaust valve 13 may be a thin part, a groove part, a valve body that is bonded by welding to the case 10, or the like. The gas exhaust valve 13 may be, for example, a linear (only longitudinal line or lateral line) notch, a conventionally known elliptical valve (with a notch inside) or circular valve (with a notch inside), or the like. The size (for example, length, depth, or the like) of the notch is arbitrarily set and can be determined as appropriate in consideration of the pressure resistance or the like of the case 10, for example.

The first sealing plate 14 and the second sealing plate 16 are plate-shaped members that seal the first opening 12e and the second opening 12f of the case main body 12. The first sealing plate 14 and the second sealing plate 16 have an approximately rectangular shape in a plan view. Here, the first sealing plate 14 and the second sealing plate 16 constitute the pair of third surfaces.

As illustrated in FIG. 1, the first sealing plate 14 includes a liquid injection hole 17. The liquid injection hole 17 is used to inject the electrolyte solution into the case 10 after the first sealing plate 14 and the second sealing plate 16 are assembled to the case main body 12. The liquid injection hole 17 is sealed with a sealing member 18 after the electrolyte solution is injected. Although the liquid injection hole 17 is provided below the positive electrode terminal 30 in this embodiment, the position where the liquid injection hole 17 is provided is not limited to this position. Although the liquid injection hole 17 is provided at the first sealing plate 14 in this embodiment, the liquid injection hole 17 may alternatively be provided at the second sealing plate 16 or the case main body 12.

### <Electrode Terminal>

The positive electrode terminal 30 and the negative electrode terminal 40 are fixed to the case 10. The positive electrode terminal 30 and the negative electrode terminal 40 are fixed to surfaces of the case 10 facing each other here. Specifically, as illustrated in FIG. 1 to FIG. 3, the positive electrode terminal 30 is attached to the first sealing plate 14 and the negative electrode terminal 40 is attached to the second sealing plate 16. Specifically, the positive electrode terminal 30 is attached to the first sealing plate 14 in a state of being insulated from the first sealing plate 14. The negative electrode terminal 40 is attached to the second sealing plate 16 in a state of being insulated from the second sealing plate 16.

Although the positive electrode terminal 30 and the negative electrode terminal 40 are provided at the first sealing plate 14 and the second sealing plate 16, respectively in this embodiment, the arrangement of the positive electrode terminal 30 and the negative electrode terminal 40 is not limited to this example. In another embodiment, both the positive electrode terminal 30 and the negative electrode terminal 40 may be provided at one of the first sealing plate 14 and the second sealing plate 16. The first sealing plate 14 and the second sealing plate 16 may be provided at the case main body 12. In addition, although the positive electrode terminal 30 and the negative electrode terminal 40 are provided on the surfaces different from that of the gas exhaust valve 13 in this embodiment, the positive electrode terminal 30 and the negative electrode terminal 40 may alternatively be provided on the same surface as that of the gas exhaust valve 13.

However, in the case of providing the positive electrode terminal 30 and the negative electrode terminal 40 at the first sealing plate 14 and the second sealing plate 16, respectively as described in this embodiment, the height of the secondary battery 100 (the size in the up-down direction Z) can be reduced and the battery with the high volume energy density can be easily obtained. In this case, it is easy to configure the battery module with the high volume energy density particularly in the application for the vehicle.

The positive electrode terminal 30 is preferably made of a metal and more preferably made of aluminum or an aluminum alloy. The negative electrode terminal 40 is preferably made of a metal and more preferably made of copper or a copper alloy.

As illustrated in FIG. 3, the electrode body 20 includes, at one end part in the long side direction Y (fifth outer surface 20e to be described below), positive electrode current collection tabs 23t with a convex shape that are electrically connected to positive electrodes 23. The positive electrode current collection tabs 23t are collectively attached to a positive electrode current collection member 32. Moreover, the electrode body 20 includes, at the other end part in the long side direction Y (sixth outer surface 20f to be described below), negative electrode current collection tabs 24t with a convex shape that are electrically connected to negative electrodes 24. The negative electrode current collection tabs 24t are collectively attached to a negative electrode current collection member 42. Inside the case 10, the positive electrode current collection member 32 is attached to the first sealing plate 14 and is electrically connected to the positive electrode terminal 30. Inside the case 10, the negative electrode current collection member 42 is attached to the second sealing plate 16 and is electrically connected to the negative electrode terminal 40.

In this manner, the positive electrode terminal 30 is electrically connected to the positive electrode 23 of the electrode body 20 through the positive electrode current collection tab 23t and the positive electrode current collection member 32 inside the case 10. The negative electrode terminal 40 is electrically connected to the negative electrode 24 of the electrode body 20 through the negative electrode current collection tab 24t and the negative electrode current collection member 42 inside the case 10. Note that the structure of electrically connecting the positive electrode terminal 30 and the negative electrode terminal 40 respectively to the positive electrode 23 and the negative electrode 24 of the electrode body 20 is not limited to the illustrated one.

### <Electrolyte Solution>

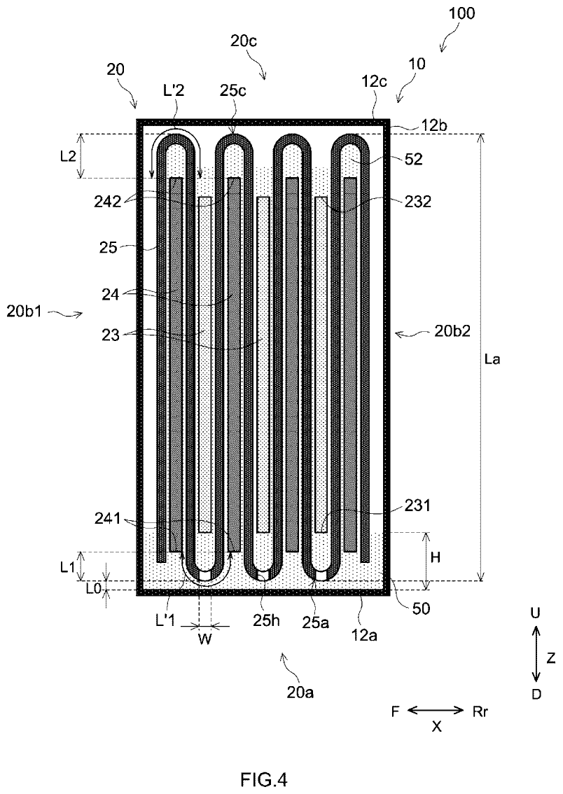

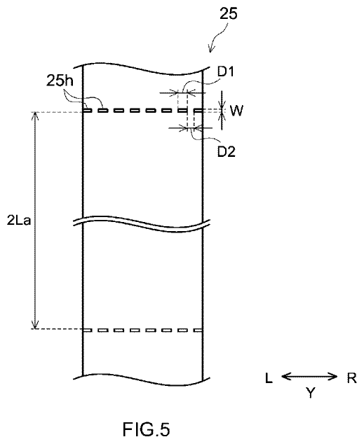

The electrolyte solution is accommodated inside the case 10 together with the electrode body 20. In this embodiment, the electrolyte solution includes the electrolyte solution permeated into the electrode body 20 (for example, an upper-retained solution 52 in FIG. 4 to be described below) and a surplus solution 50 that is not permeated into the electrode body 20 (see FIG. 4). The surplus solution 50 exists between the electrode body 20 and the case 10. Specifically, the surplus solution 50 is disposed at least between a first outer surface 20a of the electrode body 20 to be described below and the case 10.

The electrolyte solution may be similar to that in the general secondary battery without particular limitations. The electrolyte solution is preferably a nonaqueous electrolyte solution (that is, nonaqueous electrolyte solution) including a nonaqueous solvent (organic solvent) and a supporting salt. Examples of the nonaqueous solvent include carbonates such as ethylene carbonate (EC), ethyl methyl carbonate (EMC), and dimethyl carbonate (DMC). The supporting salt is also called an electrolyte salt and is, for example, a fluorine-containing lithium salt. Examples of the fluorine-containing lithium salt include LiPF₆, LiBF₄, and lithium bis(fluorosulfonyl)imide (LiFSI), and the like. The supporting salt preferably contains LiPF₆. The electrolyte solution may further contain an additive, for example, a film formation agent such as vinylene carbonate (VC) or an oxalato complex, a gas generator, a thickener, or the like.

### <Electrode Body>

The electrode body 20 is accommodated inside the case 10. FIG. 4 is a schematic longitudinal cross-sectional view taken along line IV-IV in FIG. 1 and illustrates an internal structure of the secondary battery 100. As illustrated in FIG. 4, in this embodiment, one electrode body 20 is accommodated inside one case 10. However, the number of electrode bodies 20 to be accommodated in one case 10 is not limited in particular. In another embodiment, the number of electrode bodies 20 to be accommodated in one case 10 may be plural (for example, two). Moreover, the electrode body 20 may be accommodated inside the case 10 while being wrapped with an insulating sheet (electrode body holder) made of resin.

As illustrated in FIG. 4, the electrode body 20 includes the plurality of positive electrodes 23, the plurality of negative electrodes 24, and one separator 25 disposed between the positive electrode 23 and the negative electrode 24. Since FIG. 4 is the schematic view, the positive electrode 23 and the separator 25 are illustrated apart from each other and the negative electrode 24 and the separator 25 are illustrated apart from each other. This is in order to make it easy to view each member, and in fact, the positive electrode 23 and the separator 25 are in contact with each other and the negative electrode 24 and the separator 25 are in contact with each other.

Each of electrode surfaces of the plurality of positive electrodes 23 and the plurality of negative electrodes 24 extends along a YZ surface. The plurality of positive electrodes 23 and the plurality of negative electrodes 24 are arranged in the short side direction X. The plurality of positive electrodes 23 and the plurality of negative electrodes 24 are stacked in a direction intersecting the up-down direction Z (vertical direction). Here, the short side direction X is the stacking direction of the positive electrodes 23 and the negative electrodes 24. The separator 25 insulates the positive electrodes 23 and the negative electrodes 24. The electrode body 20 is a multilayer electrode body and the impregnation with the electrolyte solution is higher than that of a wound electrode body, and in particular, the electrode body 20 is advantageous in terms of a liquid injection property of the electrolyte solution at the manufacture. In addition, by the multilayer electrode body, a battery with high volume energy density is easily configured.

Note that in this embodiment, the number of positive electrodes 23 is three, the number of negative electrodes 24 is four, and the number of separators 25 is one. However, the number of positive electrodes 23, negative electrodes 24, and separators 25 is not limited in particular and can be determined as appropriate in accordance with the battery design. In the illustrated example, the number of negative electrodes 24 is one more than the number of positive electrodes 23. Therefore, in the multilayer structure of the positive electrodes 23 and the negative electrodes 24, the outermost layers are the negative electrodes 24 on both sides. In this case, lithium contained in a positive electrode active material of the positive electrode 23 can be used sufficiently and moreover, the precipitation of lithium in the negative electrode 24 can be prevented at a high degree. In another embodiment, the number of positive electrodes 23 and the number of negative electrodes 24 may be the same or the number of positive electrodes 23 may be larger than the number of negative electrodes 24. For example, 20 or more of the positive electrodes 23 and 20 or more of the negative electrodes 24 may be provided. Moreover, the number of separators 25 may be plural (for example, two).

The positive electrode 23 may be similar to the conventional one without particular limitations. The positive electrode 23 typically includes a positive electrode current collector, and the positive electrode active material layer fixed on at least one surface of the positive electrode current collector. The positive electrode current collector is preferably made of a metal, for example, a metal foil such as an aluminum foil. In this embodiment, as illustrated in FIG. 3, the positive electrode 23 includes the part where the positive electrode current collector is exposed without the formation of the positive electrode active material layer and this exposed part forms the positive electrode current collection tab 23t.

The positive electrode active material layer contains the positive electrode active material capable of storing and releasing charge carriers reversibly. As the positive electrode active material, an oxide containing at least one kind of Ni, Co, and Mn is preferable, and examples thereof include lithium transition metal complex oxides such as lithium cobaltate, lithium manganate, lithium nickelate, a lithium nickel manganese complex oxide, and a lithium nickel cobalt manganese complex oxide. The positive electrode active material layer may contain a conductive material, a binder, or the like as necessary. Note that a carbon material such as carbon black or carbon nanotube is preferable as the conductive material. As the binder, a resin binder such as polyvinylidene fluoride is preferable.

The negative electrode 24 may be similar to the conventional one without particular limitations. The negative electrode 24 typically includes a negative electrode current collector, and a negative electrode active material layer fixed on at least one surface of the negative electrode current collector. The negative electrode current collector is preferably made of a metal, for example, a metal foil such as a copper foil. In this embodiment, as illustrated in FIG. 3, the negative electrode 24 includes the part where the negative electrode current collector is exposed without the formation of the negative electrode active material layer and this exposed part forms the negative electrode current collection tab 24t.

The negative electrode active material layer contains the negative electrode active material capable of storing and releasing charge carriers reversibly. Examples of the negative electrode active material include carbon materials such as graphite, hard carbon, and soft carbon, Si-containing materials such as Si and silicate, a Sn-containing materials such as Sn, and the like. The negative electrode active material layer may contain a conductive material, a thickener, a binder, or the like as necessary. As the binder, styrene butadiene rubber, carboxymethyl cellulose, or the like is preferable.

The separator 25 is a member that insulates between the positive electrode active material layer and the negative electrode active material layer. The separator 25 preferably includes a porous resin sheet made of resin. As the porous resin sheet, for example, a porous resin sheet made of a polyolefin resin such as polyethylene (PE), polypropylene (PP), or a mixture thereof is preferable. The porous resin sheet may have either a single-layer structure or a multilayer structure (for example, three-layer structure of PP/PE/PP).

On a surface of the porous resin sheet, a functional layer such as an adhesive layer or a heat resistance layer (HRL) can be provided as necessary. For example, the adhesive layer contains an adhesive resin such as acrylic resin or polyvinylidene fluoride. For example, the heat resistance layer contains ceramic particles of alumina, boehmite, aluminum hydroxide, titania, or the like. The heat resistance layer preferably further contains an adhesive resin. The heat resistance layer may be a layer that also serves as the adhesive layer.

In one embodiment, the separator 25 includes a base material made of the porous resin sheet and the adhesive layer provided on each surface of the base material. In another embodiment, the separator 25 includes the base material made of the porous resin sheet, the adhesive layer provided on one surface of the base material, and the heat resistance layer provided on the other surface of the base material. In this embodiment, the heat resistance layer may have a function of the adhesive layer. In still another embodiment, the separator 25 includes the base material made of the porous resin sheet, the adhesive layer provided on one surface of the base material, and the heat resistance layer provided on the other surface of the base material, and further includes a second adhesive layer provided on this heat resistance layer.

As illustrated in FIG. 4, the electrode body 20 includes the first outer surface 20a and a second outer surface 20c as a pair of outer surfaces that are disposed so as to face each other. Here, the first outer surface 20a is an outer surface on a lower side in the vertical direction and faces the bottom surface 12a of the case 10. On the first outer surface 20a, a first end surface 231 (lower end surface) of the positive electrode 23 and a first end surface 241 (lower end surface) of the negative electrode 24 are disposed. Here, the second outer surface 20c is an outer surface on an upper side in the vertical direction and faces the top surface 12c of the case 10. On the second outer surface 20c, a second end surface 232 (upper end surface) of the positive electrode 23 and a second end surface 242 (upper end surface) of the negative electrode 24 are disposed. It is preferable that, on the first outer surface 20a and the second outer surface 20c, the positive electrode current collection tab 23t and the negative electrode current collection tab 24t be not provided.

In addition, the electrode body 20 includes a third outer surface 20b1 and a fourth outer surface 20b2 as a pair of main surfaces that constitute both outer surfaces in the stacking direction of the positive electrodes 23 and the negative electrodes 24 (the short side direction X). The third outer surface 20b1 and the fourth outer surface 20b2 face the pair of long side surfaces 12b of the case main body 12. In this embodiment, the third outer surface 20b1 and the fourth outer surface 20b2 of the electrode body 20 are formed by the separator 25. In the cross-sectional view in FIG. 4, the pair of main surfaces (the third outer surface 20b1 and the fourth outer surface 20b2) are bridged by the first outer surface 20a and the second outer surface 20c. As illustrated in FIG. 3, the electrode body 20 further includes the fifth outer surface 20e and the sixth outer surface 20f as a pair of outer surfaces facing the first sealing plate 14 and the second sealing plate 16. The positive electrode current collection tab 23t is provided on the fifth outer surface 20e. The negative electrode current collection tab 24t is provided on the sixth outer surface 20f.

In this embodiment, from the viewpoint of acceptability of charge carriers, the size of the negative electrode 24 is larger than the size of the positive electrode 23 in a plan view. The area of the negative electrode 24 (the negative electrode active material layer) is larger than the area of the positive electrode 23 (the positive electrode active material layer). As illustrated in FIG. 4, the width of the negative electrode 24 (the size in the up-down direction Z) is larger than the width of the positive electrode 23. Thus, the precipitation of lithium in the negative electrode 24 can be prevented at a high degree. In another embodiment, the width of the negative electrode 24 may be the same as or smaller than the width of the positive electrode 23.

As illustrated in FIG. 4, in this embodiment, the electrode body 20 has a zigzag structure. In other words, the separator 25 has a band-like shape. That is to say, the separator 25 has a rectangular shape. Here, the separator 25 has a zigzag shape (also referred to as pleated shape) in which the separator 25 is folded alternately at a predetermined interval (length La). The separator 25 is folded alternately at end parts of the electrodes (the positive electrodes 23 and the negative electrodes 24). The separator 25 includes a first bent part and a second bent part. The length La is the entire length of the electrode body 20 in the up-down direction Z. Each of the plurality of positive electrodes 23 and the plurality of negative electrodes 24 is held alternately between folded parts of the separator 25. Since the separator 25 has the zigzag shape, the manufacturing efficiency of the multilayer type electrode body can be increased.

The separator 25 includes an electrode facing part whose cross section has an I-like shape that faces the electrodes (the positive electrode 23 and the negative electrode 24), and a pair of protrusion parts whose cross sections have a U-like shape that are folded at the end parts of the electrodes. The electrode facing part is a part that faces at least one of the positive electrode 23 (typically, the positive electrode active material layer) and the negative electrode 24 (typically, the negative electrode active material layer). The electrode facing part is positioned at a central part of the electrode body 20 in the up-down direction Z. The electrode facing part extends along the YZ surface here. The electrode facing part extends along the long side surface 12b of the case 10. The pair of protrusion parts of the separator 25 includes a plurality of first protrusion parts 25a that protrude relative to the first end surface 241 of the negative electrode 24 on the first outer surface 20a of the electrode body 20, and a plurality of second protrusion parts 25c that protrude relative to the second end surface 242 of the negative electrode 24 on the second outer surface 20c of the electrode body 20. The first protrusion part 25a and the second protrusion part 25c are parts that do not face the main surfaces of the electrodes (the positive electrode 23 and the negative electrode 24). Here, the first protrusion part 25a and the second protrusion part 25c are formed of the separator 25. The first protrusion part 25a and the second protrusion part 25c are projecting parts that project relative to the end surfaces 241, 242 of the negative electrode 24 in the up-down direction Z.

The first protrusion part 25a includes a bent part (first bent part) where the separator 25 is bent. Here, the first protrusion part 25a is bent so as to cover the first end surface 231 of the positive electrode 23. The first protrusion part 25a extends toward the bottom surface 12a of the case main body 12. The first protrusion part 25a faces the bottom surface 12a of the case 10. A distance L0 from the bottom surface 12a of the case main body 12 to a tip end of the first protrusion part 25a (a lower end, a crease part of the separator 25) is preferably 0.1 to 2.0 mm, for example.

At the first protrusion part 25a of the separator 25, a plurality of penetration holes 25h are formed. In this embodiment, the surplus solution 50 that is not permeated into the electrode body 20 exists between the first outer surface 20a of the case 10 and the electrode body 20. Thus, if the plurality of penetration holes 25h are provided at the first protrusion part 25a of the separator 25 on the first outer surface 20a side (lower side in the vertical direction) of the electrode body 20 where the surplus solution 50 exists, the electrolyte solution easily permeates into the electrode body 20 through these penetration holes 25h. Accordingly, in the secondary battery 100, the impregnation with the electrolyte solution can be effectively improved particularly on the first outer surface 20a side (lower part side) of the electrode body 20. Therefore, even after repeated charging and discharging, the occurrence of liquid shortage can be suppressed effectively and the electrolyte solution can circulate easily in the electrode body 20.

Here, the plurality of penetration holes 25h are provided at the crease part (bent part) of the separator 25. The plurality of penetration holes 25h preferably have a short straight line shape in a thickness direction of the separator 25 in a cross-sectional view. Thus, the circulation efficiency of the electrolyte solution becomes higher. For example, a ratio (Lt/t) of the shortest path length (Lt) of the penetration hole 25h in the thickness direction of the separator 25 to a thickness (t) of the separator 25 is preferably less than 1.5, more preferably less than 1.2, and still more preferably less than 1.1. Lt/t may be one. Note that the separator 25 usually includes irregularly formed minute penetration holes (micropores) through which the charge carriers can pass. However, the “penetration holes 25h” described here are distinguished from the micropores as described above and typically regularly provided, and for example, a hole diameter (for example, width W or length D1 to be described below) of the penetration hole 25h is larger than that of the micropore.

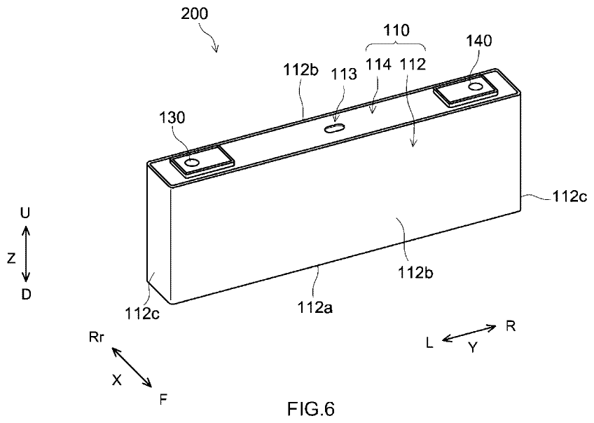

FIG. 5 is a developed view illustrating a part of the separator 25 according to one example. As illustrated in FIG. 5, the plurality of penetration holes 25h are holes with a perforated shape here. The holes with a perforated shape are regularly provided at a predetermined interval 2La along a longitudinal direction of the separator 25 with a band-like shape (a direction that is orthogonal to the long side direction Y). Here, the plurality of penetration holes 25h have a rectangular shape and are linearly disposed with a space therebetween along the long side direction Y. In another embodiment, however, the plurality of penetration holes 25h may be linearly disposed with a space therebetween along the longitudinal direction. Such a plurality of penetration holes 25h can be formed by a conventionally known method, for example, laser cutting, piercing with a blade, or the like. The size of the penetration hole 25h is not limited in particular, and can be adjusted as appropriate depending on the kind of the separator 25 to be used or the kind of the electrolyte solution, for example.

Although not limited in particular, the width W of the penetration hole 25h with a rectangular shape (length in the short side direction X) is preferably 0.1 mm or more, more preferably 0.5 mm or more, and still more preferably 1 mm or more. The length D1 of the penetration hole 25h with a rectangular shape in the long side direction is preferably 0.1 mm or more, more preferably 0.5 mm or more, and still more preferably 1 mm or more. Note that although the plurality of penetration holes 25h have a rectangular shape here, another shape (for example, square or circular shape) may be employed. From the viewpoint of improving the impregnation, the plurality of penetration holes 25h are preferably disposed linearly (for example, in a straight line shape). From the viewpoint of spreading the electrolyte solution to the electrode body 20 uniformly, the plurality of penetration holes 25h are preferably disposed regularly (at constant intervals). From the viewpoint of spreading the electrolyte solution to the electrode body 20 uniformly, an interval D2 of the plurality of penetration holes 25h is preferably 5 mm or less, and more preferably 2 mm or less.

Note that the timing to form the plurality of penetration holes 25h at the separator 25 is not limited in particular. The plurality of penetration holes 25h may be formed at the separator 25 in advance. In another example, a separator without the penetration holes 25h is prepared and before performing a step in which the plurality of positive electrodes 23 and the plurality of negative electrodes 24 are stacked, or while the plurality of positive electrodes 23 and the plurality of negative electrodes 24 are stacked, the plurality of penetration holes 25h may be formed at the separator.

The second protrusion part 25c includes a bent part (second bent part) where the separator 25 is bent. Here, the second protrusion part 25c is bent so as to cover the second end surface 242 of the negative electrode 24. The second protrusion part 25c extends toward the top surface 12c of the case main body 12. The second protrusion part 25c faces the top surface 12c of the case 10. In some embodiments, it is preferable that the plurality of penetration holes be not provided at the second protrusion part 25c of the separator 25. Thus, the electrolyte solution (the upper-retained solution 52) is easily kept at the second protrusion part 25c. In another embodiment, however, fewer penetration holes may be provided at the second protrusion part 25c of the separator 25 than at the first protrusion part 25a, for example.

As illustrated in FIG. 4, in the separator 25 in this embodiment, a protrusion length L2 of the second protrusion part 25c is larger than a protrusion length L1 of the first protrusion part 25a. That is to say, L1<L2 is satisfied. On the second outer surface 20c side (the upper side in the vertical direction) of the electrode body 20 in particular, the surplus solution 50 does not exist easily. However, when the protrusion length L2 of the second protrusion part 25c is large, the electrolyte solution (the upper-retained solution 52) is easily kept in the second protrusion part 25c. Thus, in the secondary battery 100, particularly on the second outer surface 20c side (the upper side) of the electrode body 20, the retaining property of the electrolyte solution can be improved effectively. Therefore, even after repeated charging and discharging at a high rate, the occurrence of the liquid shortage can be suppressed effectively. Moreover, the occurrence of large variation in the amount of keeping the electrolyte solution can be suppressed in each electrode (the positive electrode 23 and the negative electrode 24).

Note that as illustrated in FIG. 4, the protrusion lengths L1 and L2 are linear protrusion lengths of the protrusion parts 25a and 25c. In this embodiment, the protrusion length L1 of the first protrusion part 25a is the length of the protrusion from the first end surface 241 (specifically, the lower end part of the negative electrode active material layer) of the adjacent negative electrode 24 to the lower side (in a direction where the negative electrode 24 extends). The protrusion length L2 of the second protrusion part 25c is the length of the protrusion from the second end surface 242 (specifically, the upper end part of the negative electrode active material layer) of the negative electrode 24 to the upper side (in the direction where the negative electrode 24 extends). Note that in the secondary battery 100, the protrusion part 25a may be in a state where the protrusion part 25a is crushed by the weight of the electrode body 20 and the protrusion length L1 becomes small.

Although not limited in particular, the protrusion length L2 of the second protrusion part 25c is preferably 0.5 mm or more, and more preferably 1.0 to 5.0 mm. If the protrusion length L2 is set to the predetermined value or more, more electrolyte solution can be kept in the second protrusion part 25c; therefore, the effect disclosed herein can be achieved at a higher level. In addition, if the protrusion length L2 is set to the predetermined value or less, the charge and discharge capacity increases; therefore, the volume energy density can be increased. The protrusion length L1 of the first protrusion part 25a is preferably 0.5 to 2.0 mm. Moreover, a ratio (L2/L1) of the protrusion length L2 to the protrusion length L1 is preferably 1.2 or more, more preferably 1.5 or more, and still more preferably 2.0 to 5.0.

As illustrated in FIG. 4, in the separator 25 in some embodiments, an extension length L′2 of the second protrusion part 25c along an extension direction of the separator 25 is preferably larger than an extension length L′1 of the first protrusion part 25a along the extension direction. That is to say, L′1<L′2 is preferably satisfied. Thus, particularly on the second outer surface 20c side (the upper side) of the electrode body 20, the retaining property of the electrolyte solution can be improved more effectively.

Note that as illustrated in FIG. 4, the extension lengths L′1 and L′2 are the lengths of the protrusion parts 25a and 25c along the separator 25 (the length along a curve whose cross section has a substantially U-like shape). More specifically, for example, the extension length L′1 is the length, along the curve of the separator 25, from a position that faces the first end surface 241 of the negative electrode 24 in one root of the first protrusion part 25a (a part connecting to the electrode facing part) to a position that faces the first end surface 241 of the negative electrode 24 in the other root (a part connecting to the electrode facing part).

Although not limited in particular, the extension length L′2 of the second protrusion part 25c is typically twice or more the protrusion length L2 of the second protrusion part 25c, and is preferably 1 mm or more and more preferably 2.0 to 11.0 mm. If the extension length L′2 is set to the predetermined value or more, more electrolyte solution can be kept in the second protrusion part 25c; therefore, the effect disclosed herein can be achieved at the higher level. The extension length L′1 of the first protrusion part 25a is preferably 1.0 to 5.0 mm. Moreover, a ratio (L′2/L′1) of the extension length L′2 to the extension length L′1 is preferably 1.2 or more, more preferably 1.5 or more, and still more preferably 2.0 to 5.0.

In some embodiments, a liquid level H of the surplus solution 50 is preferably positioned above the tip end of the first protrusion part 25a of the separator 25 (the lower end, the crease part of the separator 25) when a charging ratio (SOC: state of charge) of the secondary battery 100 is 0%. Although the height of the liquid level H of the surplus solution 50 changes in the up-down direction depending on the charging ratio of the secondary battery 100, this height generally becomes the lowest in a state where the SOC is 0%. Thus, if the liquid level His adjusted to be above the first protrusion part 25a of the separator 25 in the state where the SOC is 0%, the permeation of the surplus solution 50 from the first protrusion part 25a is smoothly performed. Therefore, the effect can be achieved at the higher level.

In some embodiments, the liquid level H of the surplus solution 50 is more preferably positioned above the penetration hole 25h provided at the first protrusion part 25a of the separator 25 when the charging ratio of the secondary battery 100 is 0%. Thus, when the secondary battery 100 is charged and discharged, a state where the surplus solution 50 circulates (enters and exits) through the penetration holes 25h can be kept: therefore, the effect can be achieved at the higher level.

In some embodiments, the liquid level H of the surplus solution 50 is more preferably positioned above the first end surface 241 of the negative electrode 24 when the charging ratio of the secondary battery 100 is 0%. Thus, the permeation or the circulation of the surplus solution 50 from the first end surface 241 of the negative electrode 24 is smoothly performed, and the effect can be achieved at the particularly high level.

In some embodiments, the gas exhaust valve 13 is preferably provided on a surface of the case 10 facing the first outer surface 20a of the electrode body 20 (here, the bottom surface 12a). Thus, the gas generated in the electrode body 20 easily moves to the gas exhaust valve 13 side through the penetration holes 25h of the separator 25. Therefore, the generated gas can be exhausted easily to the outside of the case 10.

As described above, in the secondary battery 100, since the plurality of penetration holes 25h are formed at the first protrusion part 25a of the separator 25, the surplus solution 50 easily enters and exits through the penetration holes 25h; therefore, the impregnation with the electrolyte solution can be effectively improved particularly on the first outer surface 20a side (the lower part side) of the electrode body 20. In addition, in the separator 25 in the secondary battery 100, the protrusion length L2 of the second protrusion part 25c is larger than the protrusion length L1 of the first protrusion part 25a. Thus, the electrolyte solution (the upper-retained solution 52) is easily kept at the second protrusion part 25c.

Since the aforementioned effects are obtained by the art disclosed herein, even if the secondary battery 100 is charged and discharged in the state where the positive electrode 23 and the negative electrode 24 are disposed along the vertical direction (short side direction X) as illustrated in FIG. 4, the liquid shortage of the electrolyte solution does not occur easily in the electrode body 20. In addition, the variation in salt concentration in the electrode body 20 can be relieved easily. Therefore, the precipitation of lithium or the deterioration in performance due to a charging and discharging cycle can be suppressed.

The secondary battery 100 is usable in various applications. Suitable applications include the applications for vehicles, specifically a power source for driving that is mounted on a vehicle such as a battery electric vehicle (BEV), a hybrid electric vehicle (HEV), or a plug-in hybrid electric vehicle (PHEV). In addition, the secondary battery 100 can be used as an electrical energy storage battery such as a small electrical energy storage device. The secondary battery 100 can also be used in a mode of a battery module in which a plurality of the secondary batteries 100 are connected in series and/or in parallel typically.

Several test examples relating to the present disclosure will be explained below, but the present disclosure is not meant to be limited to these test examples.

### <Manufacture of Secondary Battery>

A multilayer square lithium ion battery including the multilayer electrode body as illustrated in FIG. 4 (308 mm in width×30 mm in depth×90 mm in height, 140 Ah in capacity) was manufactured. The multilayer electrode body has the zigzag structure in which the separator with the band-like shape is folded alternately in the up-down direction in use. The multilayer electrode body is assembled so that the length of the first protrusion part of the separator that protrudes from the end surface (the first end surface) of the negative electrode on the lower side (the vertical length to the crease of the separator) corresponds to L1 in Table 1 below, and the length of the second protrusion part of the separator that protrudes from the end surface (the second end surface) of the negative electrode on the upper side (the vertical length to the crease of the separator) corresponds to L2 in Table 1 below. At the crease part of the separator (the tip end of the first protrusion part), the penetration holes that have a rectangular shape with the width W (the short side direction in FIG. 4) and the length D1 are positioned at the constant interval D2. The sizes of the penetration hole are described in Table 1 below.

The amount of the injected electrolyte solution is adjusted so that the liquid level H of the surplus solution at the start of the charging and discharging cycle after the completion of the battery exists at a predetermined position from the bottom surface of an inner surface of the case. In all test examples, the liquid level H of the surplus solution and the distance L0 from the bottom surface of the case to the crease of the separator (the tip end of the first protrusion part) are common. The height of the liquid level of the surplus solution is adjusted so that even the lowest liquid level (when the charging amount is zero) is above the lower end of the negative electrode in all test examples. As described above, batteries (Examples 1 and 2, and Comparative examples 1 and 2) were manufactured.

### <Evaluation of Cycle Characteristic>

First, in an atmosphere with a temperature of 25° C., the manufactured battery was adjusted to have a state where the SOC was 50%, and a discharge pulse load was applied for ten seconds at a discharge current value I. The values obtained by dividing a voltage drop amount ΔV for ten seconds by the discharge current values I were averaged so as to calculate an IV resistance (initial resistance). Here, the measurement was performed with the current of 140 A, 280 A, and 420 A (1, 2, and 3 C) as the discharge current values I, and the values of the calculated IV resistance (initial resistance) were averaged so as to obtain the IV resistance (initial resistance).

Next, in the atmosphere with a temperature of 25° C., the manufactured battery was subjected to constant-current charging at a charging rate of 70 A (0.5 C) until a charging cut voltage of 4.2 V. Then, constant-current discharging at a discharging rate of 70 A (0.5 C) was performed until a discharging cut voltage of 2.5 V. This set of charging and discharging was regarded as one cycle. With a 60-second rest at switching between charging and discharging, 1000 cycles were repeated to perform the cycle test. Then, after the cycle test, the IV resistance was measured similarly to the initial resistance, and a resistance increase rate (%) was calculated on the basis of the ratio of the IV resistance after the cycle test to the initial resistance (the IV resistance after the cycle test/the initial resistance). The results are shown in Table 1.

TABLE 1

| | | | | | | | | | | Battery |
|---|---|---|---|---|---|---|---|---|---|---|
| | Protrusion part of separator | | | | | | Penetration hole of separator | | | evaluation |
| | Protrusion length | | | Extension length | | | Width | Length | Interval | Resistance |
| | L1 | L2 | L2/ | L′1 | L′2 | L′2/ | W | D1 | D2 | increase |
| | (mm) | (mm) | L1 | (mm) | (mm) | L′1 | (mm) | (mm) | (mm) | rate (%) |
| Example 1 | 1.0 | 2.0 | 2 | 1.2 | 2.2 | 1.8 | 1.0 | 2.0 | 2.0 | 6.3 |
| Example 2 | 1.0 | 4.0 | 4 | 1.2 | 4.2 | 3.5 | 1.0 | 2.0 | 2.0 | 4.7 |
| Comparative | 1.0 | 2.0 | 2 | 1.2 | 2.2 | 1.8 | (No opening) | | | 13.2 |
| Example 1 | | | | | | | | | | |
| Comparative | 1.0 | 0.5 | 0.5 | 1.2 | 0.7 | 0.58 | 1.0 | 2.0 | 2.0 | 11.1 |
| Example 2 | | | | | | | | | | |

As shown in Table 1, the resistance increase rate was the highest in Comparative Example 1 in which the first protrusion part of the separator did not include the penetration holes. In addition, in Comparative Example 2 in which L2<L1, the resistance increase rate was still high. It is considered that this is because the amount of electrolyte solution that was kept and circulated in the electrode body was insufficient. Note that the resistance increase rate is preferably less than 10% practically.

Compared with these Comparative Examples, the resistance increase rate was largely improved in Example 1 and Example 2 in which the first protrusion part of the separator includes the penetration holes and L1<L2. It is considered that this is because the shortage of the electrolyte solution or the variation in salt concentration inside the electrode body was suppressed. Specifically, it is considered that the surplus solution entered from the electrode end surface through the penetration holes and circulated easily inside the electrode body in the lower part (the first outer surface side) of the electrode body, and the electrolyte solution was kept easily in the second protrusion part of the separator and circulated easily inside the electrode body from the electrode end surface in the upper part (the second outer surface side) of the electrode body. Since L2 was longer in Example 2 than in Example 1 in particular, the amount of electrolyte solution that was kept in the second protrusion part increased; therefore, the resistance increase rate was suppressed further. These results indicate the technical meaning of the art disclosed herein.

The specific examples of the present disclosure have been described above in detail; however, these are examples and will not limit the scope of claims. The techniques described in the scope of claims include those in which the specific examples exemplified above are variously modified and changed.

For example, the end parts of the electrodes (the positive electrode 23 and the negative electrode 24) that are covered with the protrusion parts in the aforementioned embodiment in FIG. 4 may be changed. For example, the bent part of the separator 25 included in the first protrusion part 25a may cover the first end surface 241 of the negative electrode 24 on the first outer surface 20a side (lower side), and the bent part of the separator 25 included in the second protrusion part 25c may cover the second end surface 232 of the positive electrode 23 on the second outer surface 20c side (upper side).

In the aforementioned embodiment in FIG. 4, the surplus solution 50 exists only on the first outer surface 20a side (lower side). However, the surplus solution may exist also on the second outer surface 20c side (upper side), for example. In this case, the amount of surplus solution existing on the first outer surface 20a side (lower side) is larger than that of the surplus solution existing on the second outer surface 20c side (upper side).

The art disclosed herein is more effective in a case where the secondary battery 100 is used in a direction in which the first outer surface 20a is disposed below relative to the second outer surface 20c in the vertical direction. The art disclosed herein is particularly effective in a case where the secondary battery 100 is used in a direction in which the stacking direction of the electrodes (the positive electrode 23 and the negative electrode 24) coincides with a direction that is perpendicular to the vertical direction.

For example, in the aforementioned embodiment in FIG. 1 to FIG. 3, the positive electrode terminal 30 is attached to the first sealing plate 14 and the negative electrode terminal 40 is attached to the second sealing plate 16. As illustrated in FIG. 2, the gas exhaust valve 13 is provided at the bottom surface 12a of the case 10. However, the present disclosure is not limited to this example.

FIG. 6 is a diagram corresponding to FIG. 1 according to a modification. As illustrated in FIG. 6, in this modification, a secondary battery 200 includes a case 110. The case 110 includes a case main body 112 having one opening on one surface (the surface on the upper side), and one sealing plate 114 that closes the opening of the case main body 112 here. The case main body 112 includes a bottom surface 112a with an approximately rectangular shape, a pair of long side surfaces 112b extending from a pair of long sides of the bottom surface 112a and facing each other, and a pair of short side surfaces 112c extending from a pair of short sides of the bottom surface 112a and facing each other. Here, a positive electrode terminal 130, a negative electrode terminal 140, and a gas exhaust valve 113 are attached to one sealing plate 114 (the same surface of the case 10). In the secondary battery 200, it is also possible to apply the art disclosed herein suitably.

As described above, the following items are given as specific aspects of the art disclosed herein.
Item 1: The secondary battery including the electrode body that has the zigzag structure where the separator with a band-like shape is folded alternately so as to have the zigzag shape and the plurality of positive electrodes and the plurality of negative electrodes are held by the separator with the zigzag shape, the electrolyte solution, and the case that accommodates the electrode body and the electrolyte solution, in which the electrode body includes the pair of outer surfaces that are disposed so as to face each other, the pair of outer surfaces including the first outer surface where the first end surface of the positive electrode and the first end surface of the negative electrode are disposed, and the second outer surface where the second end surface of the positive electrode and the second end surface of the negative electrode are disposed, the electrolyte solution includes the surplus solution that is disposed at least between the first outer surface and the case, the separator includes the plurality of first protrusion parts that protrude relative to the first end surface of the negative electrode on the first outer surface, and the plurality of second protrusion parts that protrude relative to the second end surface of the negative electrode on the second outer surface, the first protrusion part includes the first bent part of the separator, the second protrusion part includes the second bent part of the separator, the plurality of penetration holes are provided at the first protrusion part, and the protrusion length L2 of the second protrusion part is larger than the protrusion length L1 of the first protrusion part.
Item 2: The secondary battery according to Item 1, in which the extension length L′2 of the second protrusion part along the extension direction of the separator is larger than the extension length L′1 of the first protrusion part along the extension direction.
Item 3: The secondary battery according to Item 1 or 2, in which the case includes the gas exhaust valve that is configured to fracture when the pressure inside the case reaches the predetermined value or more and discharge the gas in the case to the outside of the case, and the gas exhaust valve is provided on the surface of the case that faces the first outer surface of the electrode body.
Item 4: The secondary battery according to any one of Items 1 to 3, in which the liquid level of the surplus solution is positioned above the penetration hole of the separator when the charging ratio of the secondary battery is 0%.
Item 5: The secondary battery according to any one of Items 1 to 4, in which the liquid level of the surplus solution is positioned above the first end surface of the negative electrode when the charging ratio of the secondary battery is 0%.

What is claimed is:

1. A secondary battery comprising:
an electrode body that has a zigzag structure where a separator with a band-like shape is folded alternately so as to have a zigzag shape and a plurality of positive electrodes and a plurality of negative electrodes are held by the separator with the zigzag shape;
an electrolyte solution; and
a case that accommodates the electrode body and the electrolyte solution, wherein
the electrode body includes a pair of outer surfaces that are disposed so as to face each other, the pair of outer surfaces including a first outer surface where a first end surface of the positive electrode and a first end surface of the negative electrode are disposed, and a second outer surface where a second end surface of the positive electrode and a second end surface of the negative electrode are disposed,
the electrolyte solution includes a surplus solution that is disposed at least between the first outer surface and the case,
the separator includes a plurality of first protrusion parts that protrude relative to the first end surface of the negative electrode on the first outer surface, and a plurality of second protrusion parts that protrude relative to the second end surface of the negative electrode on the second outer surface,
the first protrusion part includes a first bent part of the separator,
the second protrusion part includes a second bent part of the separator,
a plurality of penetration holes are provided at the first protrusion part, and
a protrusion length L2 of the second protrusion part is larger than a protrusion length L1 of the first protrusion part.

2. The secondary battery according to claim 1, wherein an extension length L′2 of the second protrusion part along an extension direction of the separator is larger than an extension length L′1 of the first protrusion part along the extension direction.

3. The secondary battery according to claim 1, wherein
the case includes a gas exhaust valve that is configured to fracture when pressure inside the case reaches a predetermined value or more and discharge a gas in the case to outside of the case, and
the gas exhaust valve is provided on a surface of the case that faces the first outer surface of the electrode body.

4. The secondary battery according to claim 1, wherein a liquid level of the surplus solution is positioned above the penetration hole of the separator when a charging ratio of the secondary battery is 0%.

5. The secondary battery according to claim 4, wherein the liquid level of the surplus solution is positioned above the first end surface of the negative electrode when the charging ratio of the secondary battery is 0%.
